(19) United States
(12) Patent Application Publication
(10) Pub. No.: US 2022/0137467 A1
(43) Pub. Date: May 5, 2022

(54) DISPLAY PANEL AND DISPLAY DEVICE

(71) Applicant: Shenzhen China Star Optoectronics Semiconductor Display Technology Co., LTD., Shenzhen (CN)

(72) Inventor: Zhijuan LONG, Shenzhen (CN)

(21) Appl. No.: 16/620,494

(22) PCT Filed: Nov. 4, 2019
(86) PCT No.: PCT/CN2019/115272

§ 371 Date: Dec. 7, 2019

(30) Foreign Application Priority Data
Jul. 23, 2019 (CN) 201910664263.5

(51) Int. Cl. G02F 1/1343; G02F 1/1362

(52) U.S. Cl. CPC G02F 1/134345; G02F 1/134336; G02F 1/13439; G02F 1/136286

(57) ABSTRACT

The present disclosure proposes a display panel and a display device. The display panel includes a plurality of sub-pixel groups arranged in an array, each of the sub-pixel groups having at least one sub-pixel, the sub-pixel being divided into a main area and a sub-area. The display panel also includes a first metal layer having at least one first transverse trace disposed in a spacing between the main area and the sub-area, and a second metal layer having a first longitudinal trace. The first metal layer includes a first metal trace in the main area. The first metal trace surrounds the main area. The first metal layer includes a second metal trace in the sub-area. The second metal trace surrounds the sub-area. The first longitudinal trace being disposed above the first metal layer and corresponding between adjacent sub-pixel groups.

### BACKGROUND

### 1. Field of the Invention

The present disclosure relates to the field of display technology, more particularly, to a display panel and a display device.

### 2. Description of the Related Art

Liquid crystal displays (LCDs), with their advantages of high brightness, long life, wide viewing angle, large size displaying, etc., have become the mainstream display technology on the current market. In recent years, with the rapid development of the semiconductor display industry, new technologies including low temperature poly-silicon (LTPS), active-matrix organic light-emitting diode (AMOLED), micro-LED, and the like, have already threatened LCDs in small and medium-sized areas. However, LCDs still have an unbeatable position in the large-sized display area due to their mature technology and manufacturing process. Therefore, reducing the cost of LCDs and increasing the transmittance of LCDs are the main tasks of LCDs in the face of many new technical challenges.

As shown in FIG. 1, a common electrode trace 11 of each of sub-pixels 10 is located below a transparent electrode 12 of the sub-pixel 10, so that a minimum width of a formed opaque area is 9 um and a width of an opaque area formed between a main area and a sub-area is 88.5 um. It is thus understood that the widths of the opaque areas in the display panel in the related art can not be reduced, and as a result the aperture ratio of the pixel cannot be increased.

Therefore, the present disclosure provides a display panel and a display device that can effectively increase the aperture ratio of the pixel.

### SUMMARY

The technical problem to be solved by the present disclosure is as follows. The present disclosure provides a display panel and a display device. Through removing the shared common electrode from the sub-pixel structure and each pixel has its independent trace placed between the adjacent sub-pixel groups, the pixel aperture ratio is thus increased.

In order to resolve the above problem, the present disclosure provides a display panel. The display panel has a plurality of sub-pixel groups arranged in an array. Each of the sub-pixel groups has at least one sub-pixel. The sub-pixel is divided into a main area and a sub-area. The display panel comprises a first metal layer and a second metal layer. The first metal layer has at least one first transverse trace disposed in a spacing between the main area and the sub-area. The first metal layer has a first metal trace in the main area. The first metal trace surrounds the main area. The first metal layer has a second metal trace in the sub-area. The second metal trace surrounds the sub-area. The second metal layer has a first longitudinal trace. The first longitudinal trace is disposed above the first metal layer and corresponds between adjacent sub-pixel groups.

Furthermore, the display panel further comprises pixel electrodes disposed above the first metal layer and the second metal layer.

Furthermore, the sub-pixel group comprises two sub-pixels. Each of the sub-pixel groups further comprises a data line disposed between adjacent sub-pixels of the each of the sub-pixel groups. The data line is located on the second metal layer and is perpendicular to the first transverse traces.

Furthermore, the first transverse trace is a scan line.

Furthermore, two main areas and two sub-areas of the two sub-pixels correspond to liquid crystal molecules having four domains, respectively.

Furthermore, the pixel electrode comprises: a truck having a cross shape, a plurality of pixel electrode branches connected to the trunk and extending in different directions, and a closed frame connected to ends of the plurality of pixel electrode branches and the trunk.

Furthermore, the plurality of pixel electrode branches respectively extend in directions at an angle of 45°, 135°, −135°, and −45° with respect to a horizontal direction.

Furthermore, a width of the trunk is from 4 um to 9 um.

Furthermore, a width of the spacing is from 70 um to 88 um.

The present disclosure further comprises a display device comprising the display panel as provided above.

The present disclosure provides a display panel and a display device. Through removing the shared common electrode (the first longitudinal trace) from the sub-pixel structure and each pixel has its independent trace placed between the adjacent sub-pixel groups, the pixel aperture ratio is thus increased. In addition, the width of the trunk of the transparent electrode (the original position of the shared common electrode) can be reduced, and the widths of the opaque areas of the main area and the sub-area are also reduced. As a result, the pixel aperture ratio can be increased to increase the transmittance of the display panel.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural schematic diagram of a display panel in the related art.

FIG. 2 is a structural schematic diagram of a display panel according to the present disclosure.

FIG. 3 is a cross-sectional schematic diagram of a display panel according to the present disclosure.

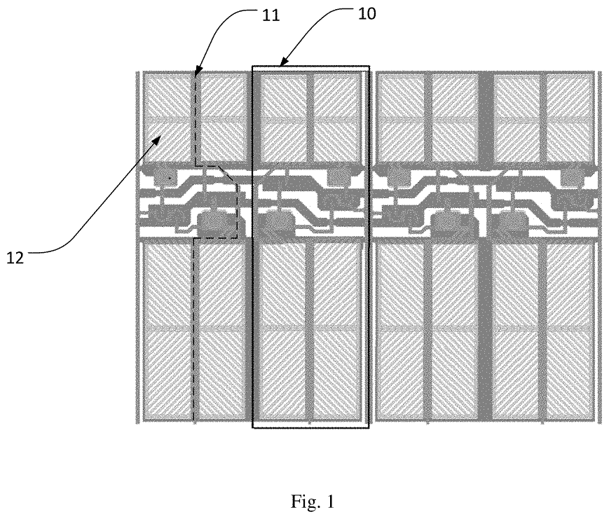

Display panel 100; First metal layer 101; Second metal layer 102; Pixel electrode 103; Sub-pixel groups 110; Sub-pixel 120; Main area 130; Sub-area 140; First transverse traces 1013; First metal trace 1011; Second metal trace 1012; Data line 1022; Trunk 1031; Pixel electrode branches 1032; Closed frame 1033.

### DESCRIPTION OF THE EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

For the purpose of description rather than limitation, the following provides such specific details as a specific system structure, interface, and technology for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details.

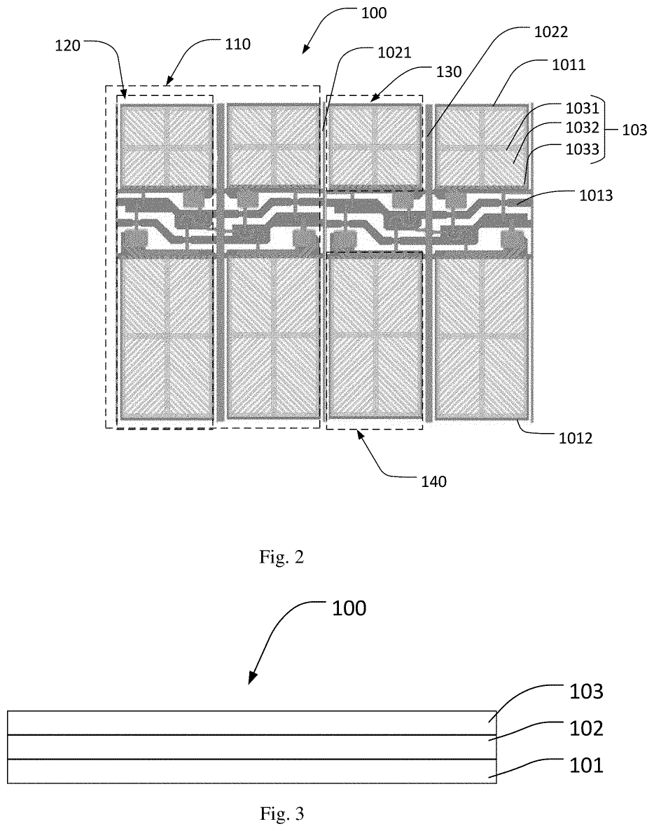

As shown in FIG. 2 and FIG. 3, the present disclosure provides a display panel 100. The display panel 100 has a plurality of sub-pixel groups 110 arranged in an array. Each of the sub-pixel groups 110 has at least one sub-pixel 120. The sub-pixel 120 is divided into a main area 130 and a sub-area 140.

The display panel 100 comprises a first metal layer 101, a second metal layer 102, and pixel electrodes 103.

The second metal layer 102 is disposed on the first metal layer 101, that is, located above the first metal layer 101.

The first metal layer 101 has at least one first transverse trace 1013 disposed in a spacing between the main area 130 and the sub-area 140.

A width of the spacing is from 70 um to 88 um, and most preferably 86.6 um. According to the present disclosure, the width of the spacing is reduced to reduce the opaque area, which in turn increases the aperture ratio.

The first metal layer 101 has two first transverse traces 1013. The first transverse trace 1013 is a scan line.

The sub-pixel group 110 comprises two sub-pixels 120. Each of the sub-pixel groups 110 further comprises a data line 1022 disposed between adjacent sub-pixels 120 of the each of the sub-pixel groups 110. The data line 1022 is located on the second metal layer 102 and is perpendicular to the first transverse traces 1013.

In the main area 130, the first metal layer 101 has a first metal trace 1011. The first metal trace 1011 surrounds the main area 130.

In the sub-area 140, the first metal layer 101 has a second metal trace 1012. The second metal trace 1012 surrounds the sub-area 140.

The first metal trace 1011 and the second metal trace 1012 form a common electrode (Acom) of the display panel 100.

The second metal layer 102 has a first longitudinal trace 1021. The first longitudinal trace 1021 is disposed above the first metal layer 101 and corresponds between adjacent sub-pixel groups 110.

The first longitudinal trace 1021 is a shared common electrode (Share com) of the display panel 100. The first longitudinal trace 1021 is removed from the sub-pixel 120 structure and placed between the adjacent sub-pixel groups 110, thus increasing the pixel aperture ratio.

The main areas 130 and the sub-areas 140 correspond to liquid crystal molecules having four domains, respectively.

The pixel electrodes 103 are disposed above the first metal layer 101 and the second metal layer 102. A material of the pixel electrode 103 is indium tin oxide.

The pixel electrode 103 comprises a trunk 1031, a plurality of pixel electrode branches 1032, and a closed frame 1033.

The trunk 1031 has a cross shape. A width of the trunk 1031 is from 4 um to 9 um, and most preferably 6 um.

Due to the removal of the shared common electrode (that is, the first longitudinal trace 1021), the width of the trunk 1031 can be further reduced to reduce the opaque areas, which can increase the aperture ratio.

The plurality of pixel electrode branches 1032 are connected to the trunk 1031 and extend in different directions. The plurality of pixel electrode branches 1032 respectively extend in directions at an angle of 45°, 135°, −135°, and −45° with respect to a horizontal direction.

The closed frame 1033 is connected to ends of the pixel electrode branches 1032 and the trunk 1031.

The present disclosure further provides a display device. The display device comprises the display panel 100.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A display panel having a plurality of sub-pixel groups arranged in an array, each of the sub-pixel groups having at least one sub-pixel, the sub-pixel being divided into a main area and a sub-area, the display panel comprising:
a first metal layer having at least one first transverse trace disposed in a spacing between the main area and the sub-area, the first metal layer having a first metal trace in the main area, the first metal trace surrounding the main area, the first metal layer having a second metal trace in the sub-area, the second metal trace surrounding the sub-area; and
a second metal layer having a first longitudinal trace, the first longitudinal trace being disposed above the first metal layer and corresponding between adjacent sub-pixel groups.

2. The display panel as claimed in claim 1, further comprising pixel electrodes disposed above the first metal layer and the second metal layer.

3. The display panel as claimed in claim 1, wherein the sub-pixel group comprises two sub-pixels, each of the sub-pixel groups further comprises a data line disposed between adjacent sub-pixels of the each of the sub-pixel groups, the data line is located on the second metal layer and is perpendicular to the first transverse traces.

4. The display panel as claimed in claim 1, wherein the first transverse trace is a scan line.

5. The display panel as claimed in claim 3, wherein two main areas and two sub-areas of the two sub-pixels correspond to liquid crystal molecules having four domains, respectively.

6. The display panel as claimed in claim 2, wherein the pixel electrode comprises:
a truck having a cross shape;
a plurality of pixel electrode branches connected to the trunk and extending in different directions; and
a closed frame connected to ends of the plurality of pixel electrode branches and the trunk.

7. The display panel as claimed in claim 6, wherein the plurality of pixel electrode branches respectively extend in directions at an angle of 45°, 135°, −135°, and −45° with respect to a horizontal direction.

8. The display panel as claimed in claim 6, wherein a width of the trunk is from 4 um to 9 um.

9. The display panel as claimed in claim 1, wherein a width of the spacing is from 70 um to 88 um.

10. A display device comprising the display panel having a plurality of sub-pixel groups arranged in an array, each of the sub-pixel groups having at least one sub-pixel, the sub-pixel being divided into a main area and a sub-area, the display panel comprising:
a first metal layer having at least one first transverse trace disposed in a spacing between the main area and the sub-area, the first metal layer having a first metal trace in the main area, the first metal trace surrounding the main area, the first metal layer having a second metal trace in the sub-area, the second metal trace surrounding the sub-area; and
a second metal layer having a first longitudinal trace, the first longitudinal trace being disposed above the first metal layer and corresponding between adjacent sub-pixel groups.

11. The display device as claimed in claim 10, wherein the sub-pixel group comprises two sub-pixels, each of the sub-pixel groups further comprises a data line disposed between adjacent sub-pixels of the each of the sub-pixel groups, the data line is located on the second metal layer and is perpendicular to the first transverse traces.

12. The display device as claimed in claim 10, wherein the first transverse trace is a scan line.
